(19) United States
(12) Patent Application Publication
(10) Pub. No.: US 2025/0256619 A1
(43) Pub. Date: Aug. 14, 2025

(54) CONTROL DEVICE FOR VEHICLE

(71) Applicant: TOYOTA JIDOSHA KABUSHIKI KAISHA, Toyota-shi (JP)

(72) Inventor: Chihiro KAMEYAMA, Nagoya-shi (JP)

(73) Assignee: TOYOTA JIDOSHA KABUSHIKI KAISHA, Toyota-shi (JP)

(21) Appl. No.: 19/019,494

(22) Filed: Jan. 14, 2025

(30) Foreign Application Priority Data
Feb. 9, 2024 (JP) 2024-019022

(51) Int. Cl. B60L 58/20; B60L 50/15

(52) U.S. Cl. CPC B60L 58/20; B60L 50/15

(57) ABSTRACT

The vehicle includes an engine, a generator coupled to the engine, a high voltage battery capable of transmitting and receiving electric power to and from the generator, a low voltage battery that supplies electric power to an auxiliary device that drives the engine, and DC/DC converters provided between the high voltage battery and the low voltage battery. The electronic control device executes an increase control for increasing the engine rotational speed, which is the rotational speed of the engine, so that the counter electromotive force generated by the generator becomes equal to or higher than the battery voltage of the high voltage battery, and supplies electric power from the high voltage battery to the low voltage battery through DC/DC converter when the generator is in the power generation amount non-control state due to the occurrence of the abnormal state.

### CROSS-REFERENCE TO RELATED APPLICATION

This application claims priority to Japanese Patent Application No. 2024-019022 filed on Feb. 9, 2024, incorporated herein by reference in its entirety.

### BACKGROUND

### 1. Technical Field

The present disclosure relates to a control device for a vehicle. The vehicle includes an engine, a generator coupled to the engine, a high voltage battery that is able to perform power transfer with the generator, a low voltage battery that supplies power to an auxiliary device driving the engine, and a DC/DC converter provided between the high voltage battery and the low voltage battery.

### 2. Description of Related Art

A control device for a vehicle is known. The vehicle includes an engine, a generator coupled to the engine, a high voltage battery that is able to perform power transfer with the generator, a low voltage battery that supplies power to an auxiliary device driving the engine, a DC/DC converter provided between the high voltage battery and the low voltage battery, and an electric motor that is a traveling power source driven by power supplied from the high voltage battery. For example, the control device is described in Japanese Unexamined Patent Application Publication No. 2000-245009 (JP 2000-245009 A).

### SUMMARY

In the control device for a vehicle described in JP 2000-245009 A, when an abnormality of a traveling electric motor is detected, damage of the electric motor is held to a minimum limit by setting the electric motor to a “non-driven state” in which the electric motor is not driven and controlled. In this case, since power with an output voltage of the generator that is lowered is directly or indirectly supplied to the low voltage battery and the auxiliary device, the low voltage battery and the auxiliary device function as normal. Therefore, even when the electric motor is in the non-driven state, travel with a traveling power source as the engine is possible.

Incidentally, when an abnormality of the generator is detected, for example, it is conceivable to hold damage of the generator to a minimum limit by setting the generator to a “power generation amount non-control state” in which the generator is not adjusted to an excitation current of a rotor coil corresponding to a rotational speed of the generator. In this case, there is a risk that a power supply from the generator to the high voltage battery is interrupted. If a power supply from the high voltage battery to the low voltage battery and the auxiliary device continues by the DC/DC converter even when the electric motor to which power is supplied from the high voltage battery is in the non-driven state, a power storage amount of the high voltage battery gradually decreases. As a result, there is a risk that auxiliary device battery exhaustion, in which a power supply to the auxiliary device is no longer possible, occurs and traveling is not possible with the traveling power source set as the engine.

The present disclosure has been made in view of the circumstances as a background, and an objective of the present disclosure is to provide a control device for a vehicle that can suppress a decrease in a travelable distance of the vehicle even when a generator is set to a power generation amount non-control state due to an occurrence of an abnormal state.

The main point of the present disclosure is a control device for a vehicle including an engine, a generator coupled to the engine, a high voltage battery that is able to perform power transfer with the generator, a low voltage battery that supplies power to an auxiliary device driving the engine, the low voltage battery having a lower voltage than a voltage of the high voltage battery, and a DC/DC converter provided between the high voltage battery and the low voltage battery, in which
when the generator is set to a power generation amount non-control state due to an occurrence of an abnormal state, the control device executes an increase control that causes a rotational speed of the engine to increase so that a counter electromotive force generated in the generator becomes equal to or more than a voltage of the high voltage battery, and the control device supplies power from the high voltage battery to the low voltage battery via the DC/DC converter.

According to the present disclosure,
when the generator is set to a power generation amount non-control state due to an occurrence of an abnormal state, an increase control is executed that causes a rotational speed of the engine to increase so that a counter electromotive force generated in the generator becomes equal to or more than a voltage of the high voltage battery, and power is supplied from the high voltage battery to the low voltage battery via the DC/DC converter.
When the generator is set to the power generation amount non-control state, an increase control is executed so that a counter electromotive force generated in the generator becomes equal to or more than a voltage of the high voltage battery. As a result, a power supply from the high voltage battery to the low voltage battery voltage battery is continued by the DC/DC converter. As a result, since a decrease of a power storage amount of the high voltage battery is suppressed and an occurrence of auxiliary device battery exhaustion is suppressed, a decrease in a travelable distance of the vehicle is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle including an electronic control device according to an embodiment of the present disclosure, and is a functional block diagram illustrating a main part of a control function for various types of control in the vehicle;

FIG. 2 is an explanatory view of the high voltage battery, the inverter, the generator, DC/DC converter, and the battery system ECU shown in FIG. 1; and

FIG. 3 is an example of a flowchart illustrating a main part of a control operation of the electronic control device illustrated in FIG. 1.

### DETAILED DESCRIPTION OF EMBODIMENTS

Hereinafter, examples of the present disclosure will be described in detail with reference to the drawings. Note that, in the following embodiments, the drawings are appropriately simplified or modified, and the dimensional ratios, shapes, and the like of the respective portions are not necessarily drawn accurately.

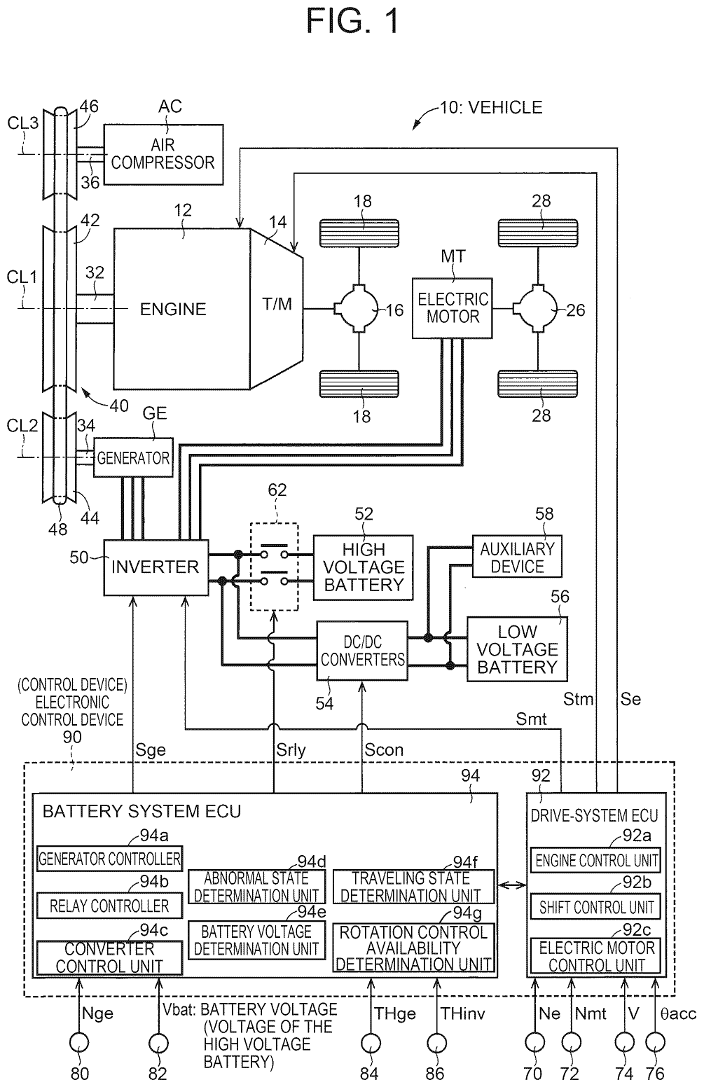

FIG. 1 is a schematic configuration diagram of a vehicle 10 including an electronic control device 90 according to an embodiment of the present disclosure, and is a functional block diagram illustrating a main part of a control function for various types of control in the vehicle 10.

The vehicle 10 includes, in order from the engine 12 side, a transmission 14 and a front wheel differential 16 in a power transmission path between the engine 12 and the pair of front wheels 18. At the same time, a rear wheel differential 26 is provided in a power transmission path between the electric motor MT and the pair of rear wheels 28. These are well known configurations. The vehicle 10 includes a belt transmission device 40, a generator GE, an inverter 50, a high voltage battery 52, a DC/DC converter 54, a low voltage battery 56, an auxiliary device 58, a system main relay 62 (hereinafter, simply referred to as “relay 62”), and an air compressor AC, which are well known in the art. Further, the vehicle 10 includes an electronic control device 90.

The engine 12 is a well-known internal combustion engine and is a traveling power source a pair of front wheels 18 of the vehicle 10. In the engine 12, the engine torque Te[Nm] which is the output torque of the engine 12 is controlled by controlling the auxiliary device 58 such as a throttle actuator, a fuel injection device, and an ignition device provided in the engine 12 by the electronic control device 90. The auxiliary device 58 is a device for causing the main body of the engine 12 to function. In this specification, the torque, the power, the driving force, and the force (power) are consensus unless otherwise specified.

The transmission 14 is constituted by, for example, a known torque converter or an automatic transmission.

The electric motor MT is a rotary electric machine having at least an electric motor function among an electric motor function and a generator function, and is, for example, a three-phase synchronous motor generator of a so-called motor generator. The electric motor MT is a traveling power source the pair of rear wheels 28 of the vehicles 10. The electric motor MT corresponds to an “electric motor” in the present disclosure.

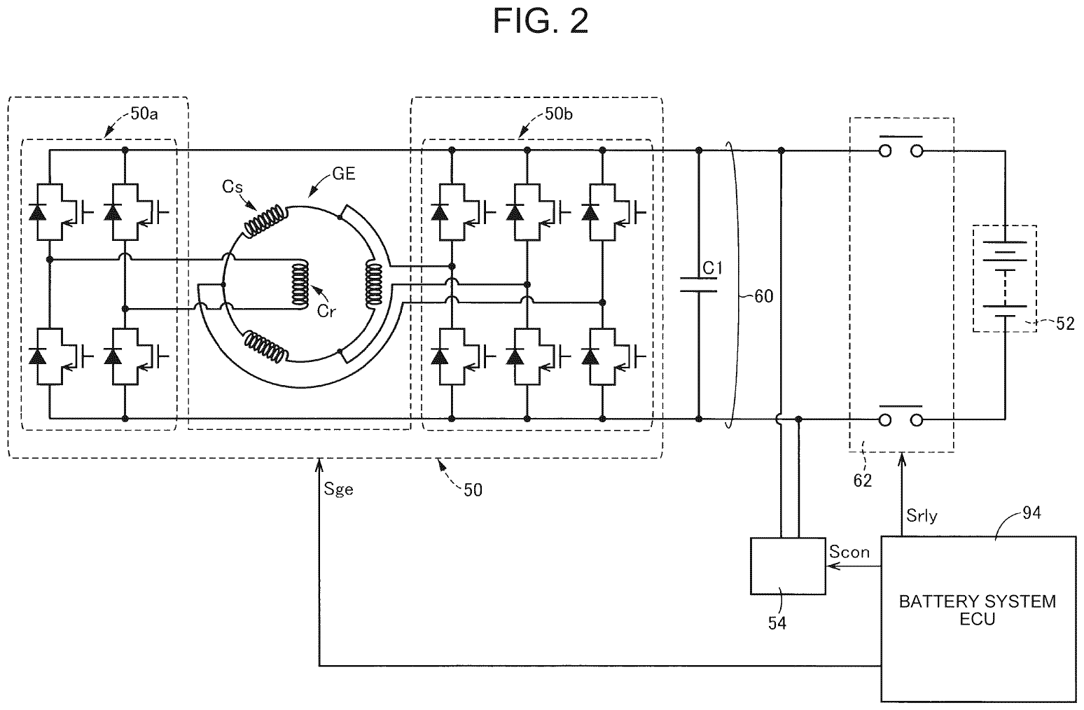

The generator GE is a rotary electric machine having at least a generator function among an electric motor function and a generator function. The generator GE includes a stator (=stator) and a rotor (=rotor), which are not shown. For example, in the generator GE, a stator coil Cs (see FIG. 2) is wound around the stator, and a permanent magnet of a surface-magnet type or an embedded magnet type is provided on the rotor, and a rotor coil Cr (see FIG. 2) is wound around the rotor. The generator GE corresponds to the “generator” in the present disclosure. When the rotor is rotated, the generator GE generates a rotating magnetic field in which the magnetic flux generated by the permanent magnet and the magnetic flux generated by the electromagnet formed by the excitation current flowing through the rotor coil Cr are rotated. As a result, a counter electromotive force Vemf is generated in the stator coil Cs, and the generator GE generates electricity. Further, in the generator GE, when three-phase alternating current is supplied to the stator coil Cs, the rotor 10 is rotated. When the generator GE is generating electricity, the generator GE functions as an alternator. When the output torque, which is the power running torque, is output from the generator GE, the generator GE functions as a starter motor that outputs the cranking torque to the engine 12. The generator GE of the present embodiment has both an electric motor function and a generator function.

15 The belt transmission device 40 connects the engine 12, the generator GE, and the air compressor AC to each other. The belt transmission device 40 is a known belt-type transmission device including a crank pulley 42 connected to the crankshaft 32 of the engine 12 so as not to be relatively rotatable, a generator pulley 44, a AC pulley 46, and a belt 48 wound between the crank pulley 42, the generator pulley 44, and AC pulley 46. The generator pulley 44 is connected to the rotor shaft 34, which is a rotating shaft of the rotor 20 of the generator GE, so as not to be relatively rotatable. AC pulley 46 is connected to the drive shaft 36 of the air compressor AC so as not to be relatively rotatable. The crankshaft 32, the rotor shaft 34, and the drive shaft 36 are rotating members having the first axis CL1, the second axis CL2, and the third axis CL3 as rotational centerlines, respectively. The first 25 axis CL1, the second axis CL2, and the third axis CL3 are parallel to each other. The belt 48 is an endless ring-shaped transmission member capable of transmitting power between the engine 12 and the generator GE. For example, the belt 48 is an endless annular compression type transmission belt capable of transmitting power between the crank pulley 42 and the generator pulley 44, or an endless annular tension type transmission belt.

30 The generator GE is connected to the high voltage battery 52 via inverters 50. The inverter 50 is a power supply circuit controlled by the electronic control device 90 to convert a direct current into an alternating current or convert an alternating current into a direct current. For example, the inverter 50 controls the excitation current Icr flowing through the rotor coil Cr of the generator GE by Pulse Width Modulation (PWM) controlling the direct current supplied from the high voltage battery 52. Further, the inverter 50 converts the three-phase alternating-current generated electric power Wge generated by the generator GE into a direct current and outputs the direct current to the high voltage battery 52. The inverters 50 also control the excitation current Ics that converts the direct current supplied from the high voltage battery 52 into three-phase alternating current and flows to the stator-coil Cs of the generator GE.

By controlling the inverters 50 by the electronic control device 90, the excitation current Icr[Nm of the generator GE is adjusted. The excitation current Icr is adjusted according to, for example, a generator rotational speed Nge [rpm] which is a rotational speed of the generator GE. When the excitation current Ier is the same, the higher the generator rotational speed Nge, the larger the generated electric power Wge. When the generator rotational speeds Nge are the same, the generated electric power Wge increases as the excitation current Ier increases. Therefore, in order to obtain the required generated electric power Wge, when the generator rotational speed Nge is relatively low, the excitation current Ier is adjusted to be large. When the generator rotational speed Nge is relatively high, the excitation current Icr is adjusted so as to be small.

The high voltage battery 52 is a rechargeable secondary battery. The high voltage battery 52 is used to supply electric power to the electric motor MT and the generator GE, or to charge the generated electric power Wmt at the electric motor MT and the generated electric power Wge at the generator GE by regeneration. The high voltage battery 52 is a battery capable of transmitting and receiving electric power to and from the generator GE.

The low voltage battery 56 is a rechargeable secondary battery. The low voltage battery 56 is used to supply power to an electric load including an auxiliary device 58 (for example, a throttle actuator, a fuel injection device, an ignition device, various sensors, a switch, and the like). Due to application differences, the low voltage battery 56 has a lower voltage than the high voltage battery 52. That is, the battery voltage Vbat of the high voltage battery 52 is higher than that of the low voltage battery 56. For example, the low voltage battery 56 is 12 [V] while the high voltage battery 52 is at a higher voltage. The battery voltage Vbat is the battery voltage of the high voltage battery 52 and corresponds to the “voltage of the high voltage battery” in the present disclosure.

DC/DC converters 54 are provided between the high voltage battery 52 and the low voltage battery 56, and are power supply circuits that step up or step down the direct current. For example, DC/DC converters 54 step down the direct current supplied from the high voltage battery 52, and output a direct current having a voltage lower than that of the high voltage battery 52 to the low voltage battery 56.

The relay 62 is a switch that disconnects and supplies electric power between the high voltage battery 52 and the inverters 50 and DC/DC converters 54.

The air compressor AC is a well-known air compressor.

Here, the crank pulley 42 is defined as a radial R1 [mm], the generator pulley 44 is defined as a radial R2 [mm], and the radial R2 divided by the radial R1 is defined as a predetermined rotational ratio α (=R2/R1) in the belt transmission device 40.

The air compressor AC can be switched between an operating state and a stopped state. For example, AC pulley 46 is connected to the drive shaft 36 of the air compressor AC via a not-shown clutch. When the clutch is brought into the engaged state, the rotation of AC pulley 46 is transmitted to the drive shaft 36, and thus the air compressor AC is brought into the operating state. When the clutch is released, AC pulley 46 idles with respect to the drive shaft 36, and thus the air compressor AC is stopped.

The electronic control device 90 includes a drive-system ECU 92 and a battery system ECU 94 that function as a control device for controlling each unit of the vehicles 10. Note that the electronic control device 90 corresponds to a “control device” in the present disclosure. The drive-system ECU 92 is an ECU that mainly controls the operation of the drive system including the engine 12, the transmission 14, and the electric motor MT of the vehicle 10. The battery system ECU 94 is an ECU that mainly controls the operation of the battery system including the generator GE, the relays 62, and DC/DC converters 54. For example, the drive-system ECU 92 and the battery system ECU 94 in the electronic control device 90 are respectively connected to a communication network using Controller Area Network (CAN) communication circuit. This allows ECU to input and output data to and from each other. ECU includes, for example, a so-called microcomputer including a CPU, RAM, ROM, an input/output interface, and the like. CPU performs various kinds of control of the vehicles 10 by performing signal-processing in accordance with a program stored in ROM in advance while using a temporary storage function of RAM.

The drive-system ECU 92 receives various types of signals and the like based on the detected values by various sensors and the like provided in the vehicles 10. Examples of the various sensors include an engine rotational speed sensor 70, an electric motor rotation speed sensor 72, a vehicle speed sensor 74, and an accelerator operation amount sensor 76. The various types of signals include, for example, an engine rotational speed Ne [rpm] which is a rotational speed of the engine 12, an electric motor rotational speed Nmt [rpm] which is a rotational speed of the electric motor MT, a vehicle speed V [km/h], and an accelerator operation amount θacc [%] as an acceleration operation amount representing a magnitude of the acceleration operation by the driver. The electric motor rotation speed sensor 72 is, for example, a resolver capable of detecting a phase representing a rotation position of a rotor of the electric motor MT, that is, capable of detecting a rotation angle and a rotation speed.

The battery system ECU 94 receives various types of signals and the like based on the detected values of various sensors and the like provided in the vehicle 10. Examples of the various sensors include a generator rotation speed sensor 80, a battery voltage sensor 82, a generator temperature sensor 84, and an inverter temperature sensor 86. The various types of signals include, for example, a generator rotational speed Nge [rpm] which is a rotational speed of the generator GE, a generator temperature THge which is a temperature of the generator GE, and an inverter temperature THinv which is a temperature of the inverter 50. The generator rotation speed sensor 80 is, for example, a resolver capable of detecting a phase representing a rotation position of a rotor of the generator GE, that is, capable of detecting a rotation angle and a rotation speed.

Various command signals are outputted from the drive-system ECU 92 to the respective apparatuses included in the vehicles 10. Each device provided in the vehicle 10 is, for example, an engine 12, a transmission 14, an inverter 50, or the like. Various command signals are, for example, an engine control signal Se for controlling the engine 12, a shift control signal Stm for executing shift control of the transmission 14, and an electric motor control signal Smt for executing rotational control of the electric motor MT via the inverter 50.

Various command signals are outputted from the battery system ECU 94 to the respective apparatuses included in the vehicles 10. The devices included in the vehicles 10 are, for example, inverters 50, relays 62, and DC/DC converters 54. The various command signals are, for example, a generator control signal Sge for controlling the excitation current Icr and the excitation current Ics of the generator GE via the inverter 50, a converter control signal Scon for controlling the voltage-conversion of the relay control signal Srly, DC/DC converter 54 for controlling the opening and closing of the relay 62, and the like.

Hereinafter, the generator GE is brought into the power generation amount non-control state due to the occurrence of the abnormal state. In the generator GE, the “power generation amount control state” refers to a state in which the excitation current Icr is adjusted and controlled in accordance with the generator rotational speed Nge. The “power generation amount non-control state” refers to a state in which the excitation current Ier is set to a predetermined constant value (for example, zero) regardless of the generator rotational speed Nge.

The drive-system ECU 92 functionally includes an engine control unit 92a, a shift control unit 92b, and an electric motor control unit 92c. The battery system ECU 94 functionally includes a generator control unit 94a, a relay control unit 94b, a converter control unit 94c, an abnormal state determination unit 94d, a battery voltage determination unit 94c, a traveling state determination unit 94f, and a rotation control availability determination unit 94g.

During vehicle running, the engine control unit 92a controls the engine torque Te so as to realize the required drive torque Trdem for the vehicle 10. The shift control unit 92b performs shift control of the transmission 14, and the electric motor control unit 92c controls the motor torque Tmt which is the torque of the electric motor MT. The required drive torque Trdem is the driving torque requested by the driver to the vehicle 10. The required drive torque Trdem is calculated, for example, by applying the actual accelerator operation amount θacc and the actual vehicle speed V to a map in which the relation between the accelerator operation amount θacc and the vehicle speed V and the required drive torque Trdem is experimentally or designedly predetermined and stored.

In the power generation control of the generator GE, the generator control unit 94a adjusts the excitation current Ier so that the generated electric power Wge required by the generator GE can be obtained by using the power of the engine 12. That is, the generator control unit 94a sets the generator GE to the power generation quantity control status.

The relay control unit 94b controls the opening and closing of the relay 62.

The converter control unit 94c performs switching control between the operating state and the stopped state with respect to the operating state of DC/DC converter 54.

The abnormal state determination unit 94d determines whether or not an abnormal state in which the generator GE needs to be in the power generation amount non-control state has occurred. For example, when the generator temperature THge exceeds the predetermined temperature determination value THge_jdg, it is determined that an abnormal state has occurred. The predetermined temperature determination value THge_jdg is a determination value determined experimentally or designedly in order to determine that an abnormal state in which the generator GE needs to be in a power generation amount non-control state has occurred. For example, when the generator rotational speed Nge is not a value corresponding to the engine rotational speed Ne or when the phase representing the rotational position of the rotor of the generator GE does not change, it is determined that an abnormal state has occurred. These may be caused, for example, by a failure of the generator rotation speed sensor 80.

When the abnormal state determination unit 94d determines that an abnormal state has occurred, the generator control unit 94a sets the generator GE to the power generation amount non-control state, and the electric motor control unit 92c sets the electric motor MT to the non-driven state. For example, the generator control unit 94a sets the excitation current Icr to zero. This is to suppress abnormally increasing the generated electric power Wge even when the actual generator rotational speed Nge is higher by using only the permanent magnets as the magnetic flux from the rotor of the generator GE toward the stator. This suppresses an increase in the generator temperature THge. As described above, in the generator GE, the magnetic flux by the permanent magnets is smaller than the magnetic flux by the electromagnets formed by the excitation current Icr. When the generator GE is placed in a power generation amount non-control state, damages to the generator GE are minimized. When the electric motor MT is non-driven state, a decrease in the storage capacity of the high voltage battery 52 is suppressed. When the abnormal state determination unit 94d determines that an abnormal state has occurred, the vehicle 10 performs limp home by engine traveling using a traveling power source as the engine 12.

The battery voltage determination unit 94c determines whether or not the battery voltage Vbat is less than a predetermined voltage determination value Vbat_jdg. The predetermined voltage determination value Vbat_jdg is, for example, a determination value determined experimentally or designedly in advance, in which the limp home by the engine travel is temporarily enabled even when the battery system is stopped. That is, when the battery voltage Vbat is equal to or greater than the predetermined voltage determination value Vbat_jdg, the low voltage battery 56 is capable of supplying power to the auxiliary device 58.

The traveling state determination unit 94f determines whether or not the vehicle 10 is in the traveling state, that is, whether or not the vehicle speed V is zero.

In some cases, the generator GE is in a power generation amount non-control state and the vehicle 10 is in a traveling state due to the occurrence of an abnormal state. In this case, the rotation control availability determination unit 94g determines whether or not the engine rotational speed Ne can be increased so that the counter electromotive force Vemf generated in the generator GE becomes equal to or higher than the battery voltage Vbat. For example, the counter electromotive force Vemf may not be increased above the battery-voltage Vbat. Further, even if the counter electromotive force Vemf can be increased to be equal to or higher than the battery voltage Vbat, the vehicle acceleration Acc, which is an acceleration toward the traveling direction of the vehicle 10 due to an increase in the engine rotational speed Ne, may be out of a predetermined allowance range. In all of these cases, it is determined that the engine rotational speed Ne cannot be increased. The predetermined allowance range is a range in which the vehicle acceleration Acc is equal to or less than the acceleration determination value Acc_jdg. The acceleration determination value Acc_jdg is a predetermined determination value determined experimentally or designedly in advance, in which the driver's sense of discomfort is within an allowable range. The range of the acceleration determination value Acc_jdg or less corresponds to “within a predetermined allowance range” in the present disclosure.

FIG. 2 is an explanatory diagram of the high voltage battery 52, the inverter 50, the generator GE, DC/DC converter 54, and the battery system ECU 94 shown in FIG. 1. In FIG. 2, the drive circuit of the electric motor MT in the configuration of the inverter 50 is omitted.

The inverter 50 includes a rotor coil control circuit 50a and a stator coil control circuit 50b.

The rotor coil control circuit 50a is a circuit that controls the excitation current Icr of the rotor coil Cr. As described above, for example, the rotor coil control circuit 50a controls the magnitude of the excitation current Ier of the rotor coil Cr by PWM control. As shown in FIG. 2, for example, in the rotor coil control circuit 50a, two pairs of switching elements connected in series are provided between the positive electrode line and the negative electrode line of the power line pair 60. The switching device is, for example, an insulated-gate bipolar transistor (IGBT), a power MOSFET, or the like. Diodes are connected in parallel to each of the switching elements. Each set of connecting points of the pair of switching elements connected in series is connected to one terminal and the other terminal of the rotor-coil Cr in the generator GE.

The stator coil control circuit 50b is a circuit that controls the excitation current Ics of the stator coil Cs. As shown in FIG. 2, for example, in the stator coil control circuit 50b, three pairs of switching elements connected in series are provided between the positive electrode line and the negative electrode line of the power line pair 60. Diodes are connected in parallel to each of the switching elements. The connection points of the pair of switching elements connected in series are connected to the respective connection terminals of the U-phase, the V-phase, and the W-phase of the stator-coil Cs in the generator GE.

The relay 62 is provided between the high voltage battery 52 and the power line pair 60. That is, the high voltage battery 52 is connected to the power line pair 60 via the relay 62. The power line pair 60 includes a pair of positive and negative electrode lines.

The relay 62 is, for example, a mechanical relay in which a closed state (connected state) in which the relay 62 is closed and an open state (shut-off state) in which the relay 62 is open are switched by the battery system ECU 94. The relay 62 is provided between the positive electrode of the high voltage battery 52 and the positive electrode line of the power line pair 60, and between the negative electrode of the high voltage battery 52 and the negative electrode line of the power line pair 60. The relay 62 is an opening/closing device that disconnects and connects the high voltage battery 52 and the power line pair 60.

A smoothing capacitor C1 is provided between the power line pair 60 in the vicinity of the inverters 50.

For example, when all the switching elements of the rotor coil control circuit 50a and the stator coil control circuit 50b in the inverter 50 are turned off by the battery system ECU 94, the excitation current Ier becomes zero and the generator GE is brought into the power generation amount non-control state. When the engine 12 is in operation, the rotor of the generator GE is rotated in accordance with the engine rotational speed Ne. As a result, a rotating magnetic field in which the magnetic flux generated by the permanent magnets rotates is generated, and a counter electromotive force Vemf is induced in the stator coil Cs of the generator GE. The counter electromotive force Vemf induced by the generator GE is converted into a DC voltage by the diode provided in the inverter 50 and the smoothing capacitor C1 provided between the power line pair 60. The higher the generator rotational speed Nge, that is, the higher the engine rotational speed Ne, the higher the counter electromotive force Vemf.

For example, the generator rotational speed Nge required to generate the counter electromotive force Vemf can be calculated by applying the required counter electromotive force Vemf to a map in which the relation between the generator rotational speed Nge and the counter electromotive force Vemf is experimentally or designedly determined in advance based on the rotating magnetic field by the permanent magnets. Based on the generator rotational speed Nge and the predetermined rotational ratio a, an engine rotational speed Ne required to generate the required counter electromotive force Vemf is calculated.

Return to FIG. 1. When the abnormal state determination unit 94d determines that an abnormal state has occurred and the battery voltage determination unit 94c determines that the battery voltage Vbat is less than the predetermined voltage determination value Vbat_jdg, the relay control unit 94b controls the relay 62 to the open state, and the converter control unit 94c controls DC/DC converter 54 to the stopped state.

When the abnormal state determination unit 94d determines that the abnormal state has occurred, the battery voltage determination unit 94e determines that the battery voltage Vbat is equal to or higher than the predetermined voltage determination value Vbat_jdg, and the traveling state determination unit 94f determines that the vehicle 10 is not in the traveling state, the engine control unit 92a increases the engine rotational speed Ne so that the counter electromotive force Vemf generated in the generator GE becomes equal to or higher than the battery voltage Vbat, and the converter control unit 94c controls DC/DC converter 54 to an operating state so as to supply electric power from the high voltage battery 52 to the low voltage battery 56.

In some cases, the abnormal state determination unit 94d determines that an abnormal state has occurred, the battery voltage determination unit 94e determines that the battery voltage Vbat is equal to or higher than the predetermined voltage determination value Vbat_jdg, and the traveling state determination unit 94f determines that the vehicle 10 is in the traveling state. In this case, (a) when the engine rotational speed Ne can be increased and the rotation control availability determination unit 94g determines, the engine control unit 92a increases the engine rotational speed Ne as much as possible, and (b) when the rotation control availability determination unit 94g determines that it is impossible to increase the engine rotational speed Ne, the engine control unit 92a controls the engine rotational speed Ne based on the required drive torque Trdem. “Increase the engine rotational speed Ne as much as possible” means that the rotation control availability determination unit 94g can increase the engine rotational speed Ne as much as possible.

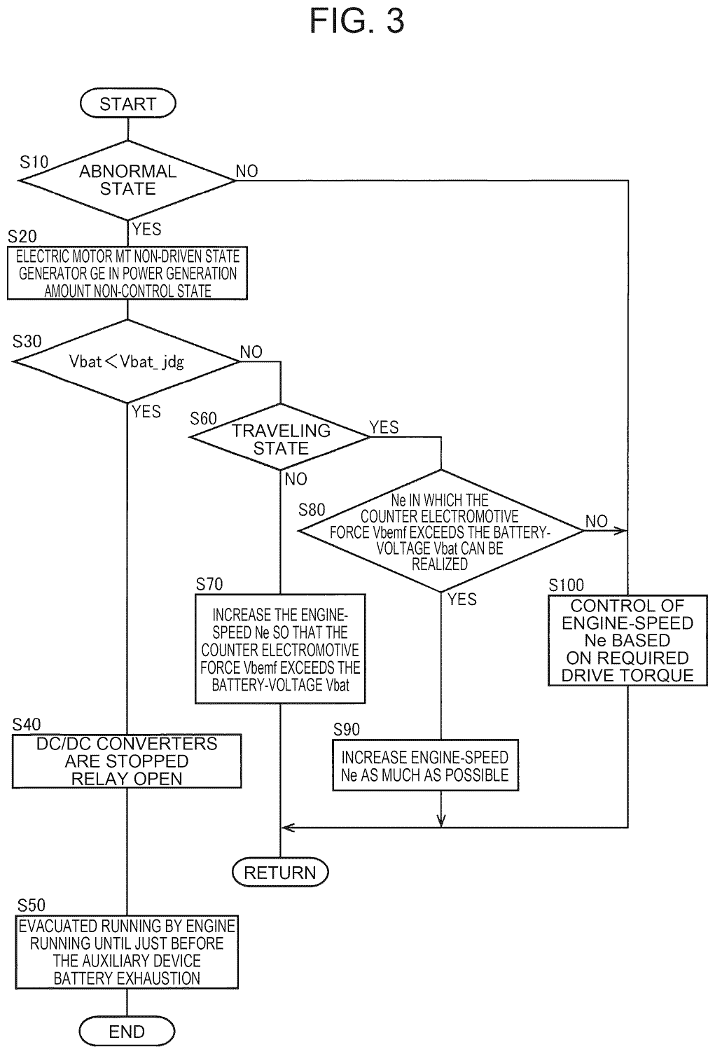

FIG. 3 is an example of a flowchart illustrating a main part of the control operation of the electronic control device 90 illustrated in FIG. 1. At the beginning of the flow chart of FIG. 3, the generator GE is in a power generation control condition.

First, in S10 corresponding to the function of the abnormal state determination unit 94d (hereinafter, the “steps” are omitted), it is determined whether or not an abnormal state in which the generator GE needs to be in the power generation amount non-control state has occurred. When the determination of S10 is YES, in S20 corresponding to the functions of the electric motor control unit 92c and the generator control unit 94a, the electric motor MT is set to the non-driven state and the generator GE is set to the power generation amount non-control state. After S20 is executed, it is determined whether or not the battery voltage Vbat is less than the predetermined voltage determination value Vbat_jdg in S30 corresponding to the function of the battery voltage determination unit 94c. When the determination of S30 is YES, the relay 62 is controlled to be in the open state and DC/DC converter 54 is controlled to be in the stopped state in S40 corresponding to the functions of the relay control unit 94b and the converter control unit 94c. After S40 is executed, in S50 corresponding to the functions of the engine control unit 92a and the shift control unit 92b, the limp home by the engine travel is temporarily executed until immediately before the auxiliary device battery exhaustion occurs. “Auxiliary device battery exhaustion” is a state in which the auxiliary device 58 cannot operate normally because the auxiliary device 58 is no longer supplied with power necessary for normal operation. After S50 is executed, the flow chart ends.

When the determination of S30 is NO, it is determined whether or not the vehicle 10 is in the traveling state in S60 corresponding to the function of the traveling state determination unit 94f. When the determination of S60 is NO, in S70 corresponding to the functions of the engine control unit 92a and the converter control unit 94c, DC/DC converter 54 is controlled to be in an operating condition so that the low voltage battery 56 is supplied with electric power from the high voltage battery 52 and the engine rotational speed Ne is increased so that the counter electromotive force Vemf generated in the generator GE becomes equal to or higher than the battery voltage Vbat. When the determination of S60 is YES, in S80 corresponding to the function of the rotation control availability determination unit 94g, it is determined whether the engine rotational speed Ne can be increased so that the counter electromotive force Vemf generated by the generator GE becomes equal to or higher than the battery voltage Vbat within the range in which the vehicle acceleration Acc is equal to or lower than the acceleration determination value Acc_jdg. When the determination of S80 is YES, the vehicle acceleration Acc can be controlled within the acceleration determination value Acc_jdg or less. When the determination of S80 is NO, the vehicle acceleration Acc cannot be controlled within the acceleration determination value Acc_jdg or less. When the determination of S80 is YES, the engine rotational speed Ne is increased in S90 corresponding to the function of the engine control unit 92a. When the determination of S10 is NO and the determination of S80 is NO, the engine rotational speed

Ne is controlled based on the required drive torque Trdem in S100 corresponding to the function of the engine control unit 92a. After S70 is executed, after S90 is executed, and after S100 is executed, both returns.

According to the present embodiment, when the generator GE is placed in the power generation amount non-control state due to the occurrence of the abnormal state, the “increase control” is executed and electric power is supplied from the high voltage battery 52 to the low voltage battery 56 through DC/DC converters 54. The increase control is a control for increasing the engine rotational speed Ne so that the counter electromotive force Vemf generated in the generator GE becomes equal to or higher than the battery-voltage Vbat. Even if the generator GE is in the power generation amount non-control state, the increase control is executed so that the counter electromotive force Vemf generated in the generator GE becomes equal to or higher than the battery voltage Vbat, so that electric power is continuously supplied from the high voltage battery 52 to the low voltage battery 56 by DC/DC converter 54. As a result, a decrease in the amount of electricity stored in the high voltage battery 52 is suppressed, and the occurrence of auxiliary device battery exhaustion is suppressed, so that a decrease in the travelable distance of the vehicle 10 is suppressed.

According to the present embodiment, if in a vehicle stop state when the

generator GE is in the power generation amount non-control state due to the occurrence of the abnormal state, the increase control is executed when the power generation amount is in the stopped state. When in the vehicle stop state, the driver does not accelerate unintentionally even if the engine rotational speed Ne increases. As a result, the vehicle acceleration Acc in which the driver feels uncomfortable is prevented, and the lowering of the travelable range of the vehicle 10 is suppressed.

According to the present embodiment, when the vehicle 10 is in the traveling state when the generator GE is in the power generation amount non-control state due to the occurrence of the abnormal state, the increase control is executed when the vehicle acceleration Acc can be controlled within the acceleration determination value Acc_jdg or less. When the vehicle acceleration Acc can be controlled within the range of the acceleration determination value Acc_jdg or less, the vehicle acceleration Acc is limited within the range of the acceleration determination value Acc_jdg or less even if the engine rotational speed Ne increases in the traveling state. This suppresses the uncomfortable feeling felt by the driver, and suppresses a decrease in the travelable distance of the vehicle 10.

According to the present embodiment, when the vehicle 10 is in the traveling state when the generator GE is in the power generation amount non-controlled state due to the occurrence of the abnormal state, and when the vehicle acceleration Acc is not controllable within the range of the acceleration determination value Acc_jdg or less, the engine rotational speed Ne is determined based on the required drive torque Trdem. When the vehicle acceleration Acc cannot be controlled within the acceleration determination value Acc_jdg or less, the engine rotational speed Ne is determined based on the required drive torque Trdem, so that unintentional acceleration by the driver is not performed. This prevents the driver from feeling uncomfortable due to the vehicle-acceleration Acc.

According to the present embodiment, the vehicle 10 includes an electric motor MT that is a traveling power source driven by electric power supplied from the high voltage battery 52, and the electric motor MT is in a non-driven state when the generator GE is in a power generation amount non-control state due to generation of an abnormal state. Since the electric motor MT is set in the non-driven state, a decrease in the amount of electricity stored in the high voltage battery 52 is suppressed, so that the electric power is easily supplied from the high voltage battery 52 to the low voltage battery 56 and the auxiliary device 58 by DC/DC converters 54, and the generation of the auxiliary device battery exhaustion is suppressed.

It should be noted that the above-described embodiments of the present disclosure are examples of the present disclosure, and the present disclosure can be implemented in various modifications and improvements based on the knowledge of a person skilled in the art without departing from the gist thereof.

In the above-described embodiment, when the generator GE is in a vehicle stop state in the power generation amount non-control state due to the occurrence of the abnormal state, the increase control is executed when the power generation amount non-control state, but the increase control may not be executed. For example, by executing the increase control in the traveling state of the vehicle 10, a decrease in the amount of electricity stored in the high voltage battery 52 is suppressed, and the occurrence of auxiliary device battery exhaustion is suppressed, so that a decrease in the travelable distance of the vehicle 10 is suppressed.

In the above-described embodiment, when the vehicle 10 is in the traveling state when the generator GE is in the power generation amount non-control state due to the occurrence of the abnormal state, the increase control is executed when the vehicle acceleration Acc is controllable within the range of the acceleration determination value Acc_jdg or less. However, the increase control may not be executed. For example, by executing the increase control in the vehicle stop state, the decrease in the amount of electric power stored in the high voltage battery 52 is suppressed, and the occurrence of the auxiliary device battery exhaustion is suppressed, so that the decrease in the travelable distance of the vehicle 10 is suppressed.

In the above-described embodiment, if the vehicle 10 is in the traveling state when the generator GE is in the power generation amount non-control state due to the occurrence of the abnormal state, the engine rotational speed Ne is determined based on the required drive torque Trdem when the vehicle acceleration Acc cannot be controlled within the range of the acceleration determination value Acc_jdg or less, but this may not be the case. For example, even when such control is not possible, the increase control may be executed. By executing the increase control, a decrease in the travelable distance of the vehicle 10 is suppressed.

In the above-described embodiment, when the generator GE is in the power generation amount non-control state due to the generation of the abnormal state, the electric motor MT is in the non-driven state, but for example, the electric motor MT may be in the driven state. Even when the electric motor MT is in the drive mode, when the increase control is executed as compared with when the increase control is not executed, a decrease in the travelable range of the vehicles 10 is suppressed.

In the above-described embodiment, the rotor of the generator GE is provided with a permanent magnet, but may be provided without the permanent magnet. For example, the rotor may not be provided with permanent magnets, and only the rotor coil Cr may be provided. In such an embodiment, the excitation current Icr may be adjusted to a predetermined constant value (>0) irrespective of the generator rotational speed Nge so that the magnetic flux from the rotor of the generator GE toward the stator becomes substantially the same as that of the permanent magnets in the above-described embodiment due to the occurrence of the abnormal state. The predetermined constant value is an empirically or designedly predetermined current value so that the generator GE is minimized from being damaged.

In the above-described embodiment, the belt transmission device 40 connects the engine 12, the generator GE, and the air compressor AC to each other. However, for example, the belt transmission device 40 may be configured such that the engine 12 and the generator GE are connected to each other, but the air compressor AC is not connected to each other.

In the above-described embodiment, the “control device” in the present disclosure is divided into a drive-system ECU 92 and a battery system ECU 94, but the present disclosure is not limited thereto. For example, the “control device” may have a configuration that is further divided for each function than in the above-described embodiment as necessary, or may have a configuration in which all the functions are integrated into one.

What is claimed is:

1. A control device for a vehicle including an engine, a generator coupled to the engine, a high voltage battery that is able to perform power transfer with the generator, a low voltage battery that supplies power to an auxiliary device driving the engine, the low voltage battery having a lower voltage than a voltage of the high voltage battery, and a DC/DC converter provided between the high voltage battery and the low voltage battery, wherein when the generator is set to a power generation amount non-control state due to an occurrence of an abnormal state, the control device executes an increase control that causes a rotational speed of the engine to increase such that a counter electromotive force generated in the generator becomes equal to or more than a voltage of the high voltage battery, and the control device supplies power from the high voltage battery to the low voltage battery via the DC/DC converter.

2. The control device according to claim 1, wherein if the vehicle is in a vehicle stop state when the generator is set to the power generation amount non-control state due to an occurrence of the abnormal state, the control device executes the increase control.

3. The control device according to claim 1, wherein if the vehicle is in a traveling state when the generator is set to the power generation amount non-control state due to an occurrence of the abnormal state, the control device executes the increase control when a vehicle acceleration is not able to be controlled within a predetermined allowance range.

4. The control device according to claim 3, wherein if the vehicle is in the traveling state when the generator is set to the power generation amount non-control state due to an occurrence of the abnormal state, a rotational speed of the engine is determined based on a required drive torque when the vehicle acceleration is not able to be controlled within the predetermined allowance range.

5. A control device according to claim 1, wherein:
the vehicle further includes an electric motor being a traveling power source driven by power supplied from the high voltage battery; and
when the generator is set to the power generation amount non-control state due to an occurrence of the abnormal state, the electric motor is set to a non-driven state.
